(19) United States
(12) Patent Application Publication
(10) Pub. No.: US 2003/0164990 A1
(43) Pub. Date: Sep. 4, 2003

(54) Facsimile apparatus and control method thereof

(75) Inventor: Masashi Watanabe, Sunto-gun (JP)

Correspondence Address: FRISHAUF, HOLTZ, GOODMAN & CHICK, PC, 767 THIRD AVENUE, 25TH FLOOR, NEW YORK, NY, 10017-2023, US

(73) Assignee: Toshiba Tec Kabushiki Kaisha, Tokyo (JP)

(21) Appl. No.: 10/079,555

(22) Filed: Feb. 19, 2002

(51) Int. Cl. H04N 1/00

(52) U.S. Cl. 358/402; 358/407

(57) ABSTRACT

If a delivery confirmation mail has arrived, it is determined whether a delivery failure of image data transmitted is notified by the delivery confirmation mail. Only if it has been determined that the delivery failure is notified, an image based on the delivery confirmation mail is printed by a printer.

### BACKGROUND OF THE INVENTION

1. Filed of the Invention

The present invention relates to a facsimile apparatus for performing image data communication utilizing a mail transmission system in a computer network such as the Internet, and a control method thereof.

2. Description of the Related Art

A facsimile apparatus for performing image communication by transmitting e-mails to which image data is attached as an attachment file is well known.

Since the facsimile apparatus of this kind transmits e-mail, a delivery confirmation function in an e-mail system can be used. Specifically, at the time of transmitting an image, it is possible to request delivery confirmation mail of the mail server or destination terminal, by indicating, in the e-mail to be transmitted, that delivery confirmation is requested.

If the conventional facsimile apparatus receives the delivery confirmation mail, the apparatus prints out the contents of the delivery confirmation mail. Therefore, the user can know, from the printed-out delivery confirmation mail, the image transmission result.

However, in the related art, all incoming delivery confirmation mail is printed out regardless of the contents. Thus, the user analyzes the printed-out delivery confirmation mail to determine whether the image successfully arrived at the transmission destination or not. Then, depending on the delivery status of the image, the user has to perform remedial action. Thus, a heavy burden is placed on the user.

### BRIEF SUMMARY OF THE INVENTION

It is an object of the present invention to reduce the burden on the user if image delivery fails.

According to an aspect of the present invention, there is provided a facsimile apparatus comprising: a communication section which performs image data communication utilizing a mail transmission system of a computer network; a printer which prints an arbitrary image; a determining section which, if a delivery confirmation mail has arrived, determines whether a delivery failure of the image data transmitted from the communication section is notified by the delivery confirmation mail; and a control section which causes the printer to print an image based on the delivery confirmation mail, only if the determining section has determined that the delivery failure is notified.

According to another aspect of the present invention, there is provided a facsimile apparatus comprising: a communication section which performs image data communication utilizing a mail transmission system of a computer network; a storage which stores image data which has been transmitted by the communication section; a determining section which, if a delivery confirmation mail has arrived, determines whether a delivery failure of the image data transmitted from the communication section is notified by the delivery confirmation mail; and a control section which causes the communication section to retransmit, when the determining section has determined that the delivery failure is notified, that image data of the image data stored in the storage, which is notified by the delivery confirmation mail as having failed to be delivered.

According to another aspect of the present invention, there is provided a method of controlling a facsimile apparatus having a communication section which performs image data communication utilizing a mail transmission system of a computer network, and a printer which prints an arbitrary image, the method comprising: determining, if a delivery confirmation mail has arrived, whether a delivery failure of the image data transmitted from the communication section is notified by the delivery confirmation mail, and causing the printer to print an image based on the delivery confirmation mail, only if it has been determined that the delivery failure is notified.

According to another aspect of the present invention, there is provided a method of controlling a facsimile apparatus having a communication section which performs image data communication utilizing a mail transmission system of a computer network, and a storage which stores image data which has been transmitted by the communication section, the method comprising: determining, if a delivery confirmation mail has arrived, whether a delivery failure of the image data transmitted from the communication section is notified by the delivery confirmation mail, and causing the communication section to retransmit, when it has been determined that the delivery failure is notified, that image data of the image data stored in the storage, which is notified by the delivery confirmation mail as having failed to be delivered.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a facsimile apparatus according to an embodiment of the present invention;

FIG. 2 is a diagram showing information notified by delivery confirmation mail;

FIG. 3 is a diagram showing a management table of delivery confirmation information;

FIG. 4 is a flowchart of IFAX transmission processing; and

FIG. 5 is a flowchart of delivery confirmation mail processing.

### DETAILED DESCRIPTION OF THE INVENTION

An embodiment of the present invention will be described below with reference to the drawings.

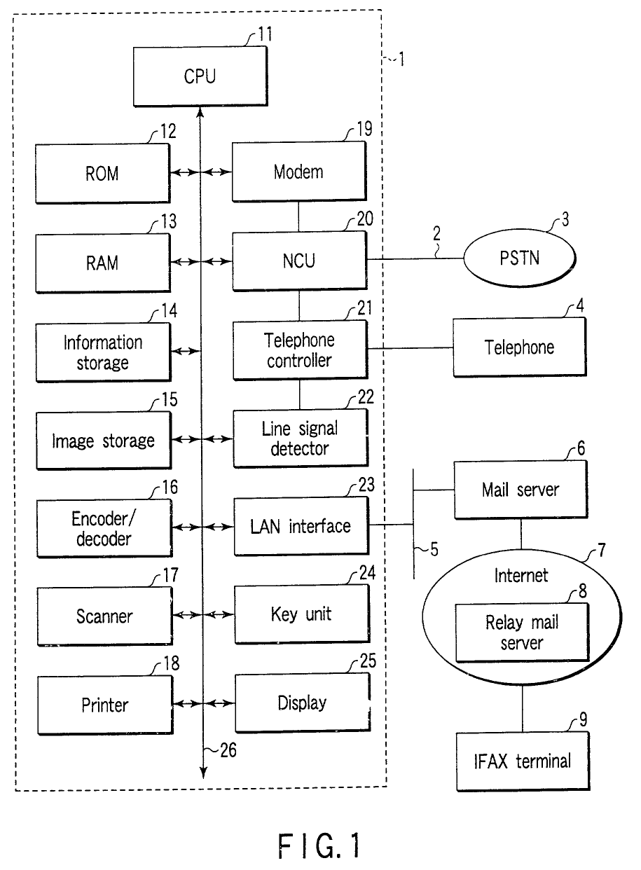

FIG. 1 is a block diagram showing a facsimile apparatus according to an embodiment of the present invention.

In FIG. 1, a facsimile apparatus according to the embodiment is denoted by reference numeral 1. The facsimile apparatus 1 comprises a CPU 11, a ROM 12, a RAM 13, an information storage 14, an image storage 15, an encoder/decoder 16, a scanner 17, a printer 18, a modem 19, an NCU 20, a telephone controller 21, a line signal detector 22, a LAN interface 23, a key unit 24, and a display 25, as shown in FIG. 1.

The CPU 11, ROM 12, RAM 13, information storage 14, image storage 15, encoder/decoder 16, scanner 17, printer 18, modem 19, NCU 20, line signal detector 22, LAN interface 23, key unit 24, and display 25 are connected to each other via a bus 26.

The CPU 11 controls each section to implement an operation as a facsimile apparatus, by performing software processing based on an operation program stored in the ROM 12.

The ROM 12 stores the operation program, etc.

The RAM 13 is used as a work area, etc., for storing various information items necessary for the CPU 11 to perform various processes.

The information storage 14 comprises, for example, a flash memory, etc. The information storage 14 stores various setting information items and other information.

The image storage 15 comprises, for example, a DRAM of a large capacity, or a hard disk device. The image storage 15 temporarily stores received image data and image data to be transmitted.

The encoder/decoder 16 performs encoding of image data for redundancy compression. The encoder/decoder 16 also performs decoding of the image data encoded for redundancy compression.

The scanner 17 reads the document to be transmitted and generates image data corresponding to the document.

The printer 18 prints out the image associated with the image data, on a printer sheet.

The modem 19 modulates image data to generate a facsimile transmission signal, and modulates a command given by the CPU 11 to generate a command transmission signal. The modem 19 sends out the transmission signals to a PSTN subscriber line 2 via the NCU 20. A facsimile transmission signal or a command transmission signal entering via the PSTN subscriber line 2 is supplied to the modem 19 via the NCU 20. The modem 19 reproduces the image data by demodulating the facsimile transmission signal, or reproduces the command by demodulating the command transmission signal.

The NCU 20 is connected to a PSTN 3 via the PSTN subscriber line 2. The NCU 20 monitors the status of the PSTN subscriber line 2 and performs call processing to the PSTN 3. The NCU 20 also equalizes the facsimile transmission signal sent from the modem 19 to the PSTN subscriber line 2, and performs setting of the output level of the facsimile transmission signal.

The telephone controller 21 is connected to the telephone 4 according to necessity. The telephone controller 21 performs well-known control to enable telephone communications via the PSTN subscriber line 2 using the connected telephone 4.

The various signals entering via the PSTN subscriber line 2 are supplied to the line signal detector 22 via the NCU 20 and the telephone controller 21. The line signal detector 22 monitors the signals supplied and detects incoming specific signals.

The LAN interface 23 is connected to a LAN 5. The LAN 5 is connected to a mail server 6. The mail server 6 is connected to the Internet 7. The LAN interface 23 performs data transmission via the LAN 5 or the Internet 7.

The key unit 24 comprises a number of key switches. The key unit 24 accepts various user instructions to the CPU 11. An important mail key is included in the key switches which constitute the key unit 24.

The display 25 comprises an LCD, for example. The display 25 displays, under control of the CPU 11, an image for notifying the user of various information items.

Incidentally, the CPU 11 performs software processing based on the operation program stored in the ROM 12, thereby operating as a print control section, a retransmission control section, an acceptance section and a request section, respectively, in addition to a well-known standard control section in a facsimile apparatus.

The print control section performs control concerning printing of the delivery confirmation mail. The retransmission control section controls retransmission of e-mails. The acceptance section accepts, at the time of accepting transmission designation, user designation to the effect that the e-mail is important, if the important mail key has been pressed down. The request section performs processing for forcedly transmitting an e-mail with a transmission confirmation request, in response to the acceptance section accepting the user designation indicating that it is important.

Next, the operation of the facsimile apparatus 1 having the above-described structure will be explained. The operation of the facsimile apparatus 1 concerning facsimile communication via the PSTN 3, image data transmission utilizing e-mail, etc., is the same as that of the conventional facsimile apparatus, thus will not be explained. The explanation will be given with particular emphasis on the operation concerning processing of the delivery confirmation mail, which is the feature of the present invention.

The facsimile apparatus 1 according to the embodiment is compliant with two delivery confirmation mails of DSN (delivery status notification) and MDN (message disposition notification) standardized under the IETF (Internet engineering task force). With respect to the DSN, if an e-mail is transmitted using ESMTP (extended simple mail transfer protocol), a relay mail server sends the DSN to the transmitter in response to the request from the transmitter. With respect to the MDN, by describing a “Disposition-Notification-To” header in the e-mail, the terminal which has received the e-mail transmits the MDN.

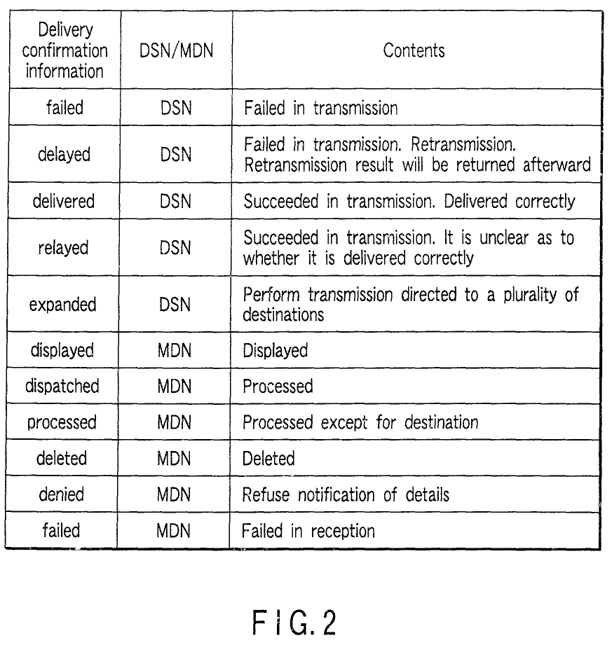

The DSN and MDN include delivery confirmation information concerning the transmission status of e-mail. The delivery confirmation information as shown in FIG. 2 is defined under the IETF.

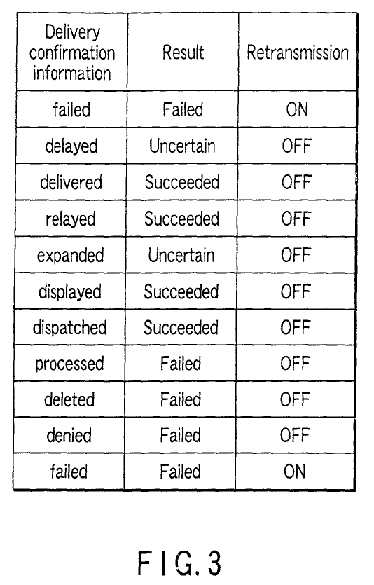

In the embodiment, a management table of delivery confirmation information as shown in FIG. 3 is prepared based on FIG. 2, and the table is stored in the information storage 14. The management table shows, concerning each delivery confirmation information item, whether the delivery result indicated by the delivery confirmation information is “failed”, “succeeded”, or “uncertain”. The management table also shows, concerning each delivery confirmation information item, whether retransmission is to be performed or not.

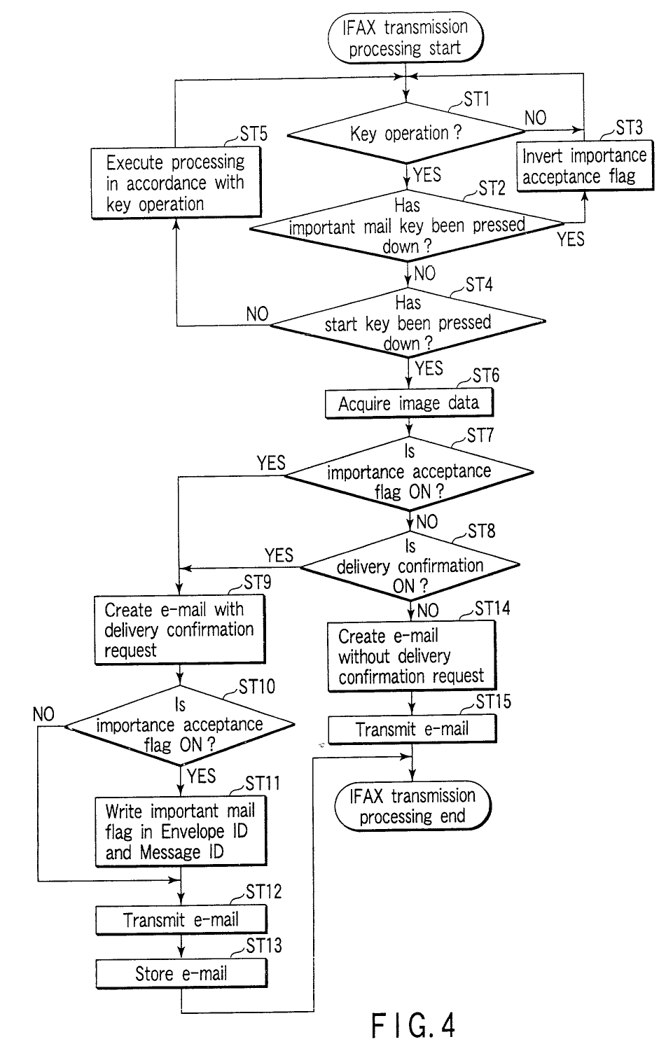

If the user requests transmission of image data via the Internet 7, the CPU 11 executes IFAX transmission processing as shown in FIG. 4.

In step ST1, the CPU 11 waits for a key operation to be performed. If a key operation by the user is performed with the key unit 24, the CPU 11 confirms whether or not the important key has been pressed down, in step ST2. If it is confirmed that the important key has been pressed down, then inverts an importance acceptance flag, in step ST3. Then the CPU 11 returns to the wait status in step ST1. The importance acceptance flag is OFF initially.

If it is confirmed in step ST2 that the important key has not been pressed down, the CPU 11 confirms whether a start key has been pressed down, in step ST4. If it is confirmed that the start key has not been pressed down, then executes processing in accordance with the key operation, in step ST5. The processing in accordance with the key operation refers to, for example, the processing involved in changing the set value of the image quality of the image to be transmitted in accordance with the key operation for instructions on image quality changing. After completing the processing in step ST5, the CPU 11 returns to the wait status in step ST1.

If it is confirmed in step ST4 that the start key has been pressed down, the CPU 11 acquires the image data by reading the document by, for example, the scanner 17, in step ST6.

In steps ST7 and ST8, the CPU 11 confirms whether either of the importance acceptance flag or delivery confirmation is ON. The user can set the delivery confirmation ON/OFF arbitrarily by, for example, the menu operation for setting functions.

If it is confirmed that either of the importance acceptance flag or delivery confirmation is ON, the CPU 11 creates e-mail in a format for requesting delivery confirmation, with a Tiff file indicating the image data acquired in step ST6 as an attachment file, and in step ST9. The CPU 11 confirms as to whether the importance acceptance flag is ON, in step ST10. If the CPU 11 confirms that the importance acceptance flag is ON, the CPU 11 writes, in step ST11, an important mail flag in an Envelope ID and Message ID in the e-mail created in step ST9. If the CPU 11 confirms that the importance acceptance flag is OFF in step ST10, the CPU 11 does not perform the processing of step ST11.

The CPU 11 transmits the e-mail to the LAN 5 via the LAN interface 23, in step ST12. If the importance acceptance flag is OFF, the e-mail created as it is in step ST9 is to be sent. If the importance acceptance flag is ON, the e-mail which is created in step ST9 and in which the important mail flag is written in step ST11 is to be sent.

If the e-mail transmission is completed, the CPU 11 stores the e-mail in, for example, the image storage 15 for retransmission, in step ST13. After the e-mail has been stored, the CPU 11 terminates the IFAX transmission processing.

On the other hand, if it is confirmed in steps ST7 and ST8 that both the importance acceptance flag and the delivery confirmation are OFF, the CPU 11 creates an e-mail in a format for not requesting delivery confirmation, with a Tiff file indicating the image data acquired in step ST6 as an attachment file, and in step ST14. In step ST15, the CPU 11 transmits the e-mail created in step ST14 to the LAN 5 via the LAN interface 23. After the e-mail has been transmitted, the CPU 11 terminates the IFAX transmission processing.

The e-mail transmitted from the facsimile apparatus 1 to the LAN 5 is transmitted to the Internet 7 by the mail server 6. The e-mail is forwarded by the arbitrary relay mail sever 8 on the Internet 7 to the destination IFAX terminal 9. If the e-mail is in a format requesting delivery confirmation, the DSN is sent back from the relay mail server 8 to the facsimile apparatus 1. If the IFAX terminal 9 is compliant with the MDN, the MDN is sent back from the IFAX terminal 9 to the facsimile apparatus 1.

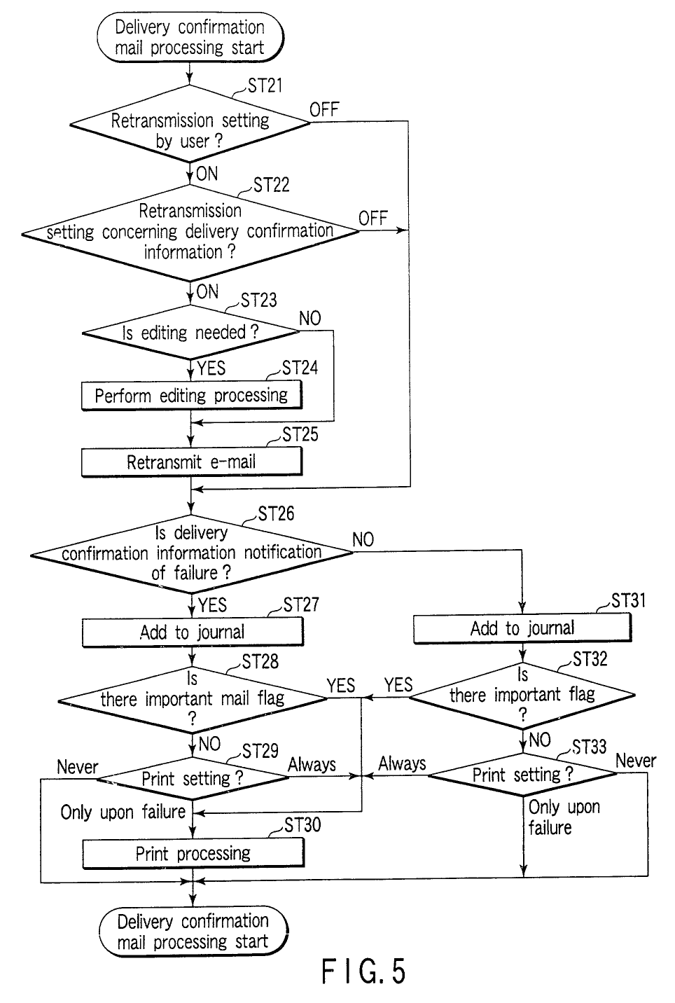

On reception of these delivery confirmation mails, the CPU 11 executes delivery confirmation mail processing as shown in FIG. 5.

In steps ST21 and ST22, the CPU 11 confirms whether both retransmission setting by the user and retransmission setting concerning the delivery confirmation information are ON. As regards the retransmission setting by the user, the user can arbitrarily set ON/OFF by the menu operation for setting functions, for example. The retransmission setting concerning the delivery confirmation information is shown in the management table of the delivery confirmation mail. The CPU 11 confirms the retransmission setting concerning the delivery confirmation information indicated in the delivery confirmation mail, in step ST22.

If both of the two retransmission settings are ON, this indicates that automatic retransmission of the e-mail is requested by the user, and that the delivery result notified by the delivery confirmation mail indicates a status in which trying to retransmit the e-mail is preferable. In this case, the CPU 11 confirms whether it is necessary to edit the e-mail, in step ST 23. More specifically, in step ST23, the CPU 11 confirms whether the e-mail failed to be delivered to the opposite terminal due to the communication capability thereof, if the delivery confirmation mail indicates the communication capability of the opposite terminal. If the CPU 11 confirms that the e-mail failed to be delivered to the opposite terminal due to the communication capability thereof, the CPU 11 determines that editing is needed.

If it is confirmed that editing is needed, the CPU 11 performs editing processing, in step ST24.

The editing processing refers to processing for changing resolution, compression method, size, etc., to enable the e-mail to be received with the communication capability of the opposite terminal. If it is confirmed that the editing is not needed in step ST23, the CPU 11 does not perform the processing of step ST24.

The CPU 11 retransmits the e-mail in step ST25. In such a case, if the CPU 11 has performed the editing processing in step ST24, the edited e-mail is transmitted. If it is confirmed in steps ST21 and ST22 that either of the retransmission settings is OFF, the CPU 11 does not perform the processing from steps ST23 to ST25. That is, the CPU 11 does not perform e-mail retransmission.

In step ST26, the CPU 11 confirms whether the delivery confirmation information is notification of failure of e-mail delivery. Specifically, the CPU 11 confirms whether the result associated with the notified delivery confirmation information in the management table is “failed”, in step ST26.

If it is confirmed that the delivery confirmation information is notification of failure of e-mail delivery, the CPU 11 adds to the journal the historical information concerning the e-mail whose delivery status is notified by the delivery confirmation mail, in step ST27. In step ST28, the CPU 11 confirms whether the Envelope ID or Message ID notified by the delivery confirmation mail includes the important mail flag. If there is no important mail flag, the CPU 11 confirms the print setting, in step ST29. As regards the print setting, the user can arbitrarily set any of “always”, “only upon failure” and “never” by, for example, the menu operation for setting functions.

If it is confirmed that the print setting is “always” or “only upon failure” in step ST29, the CPU 11 performs print processing concerning the delivery confirmation mail in step ST30. After the print processing is completed, the CPU 11 terminates the delivery confirmation mail processing. If it is confirmed in step ST29 that the print setting is “never”, the CPU 11 terminates the delivery confirmation mail processing without performing step ST30.

On the other hand, if it is confirmed that the delivery confirmation information is not notification of failure of e-mail delivery in step ST26, the CPU 11 adds to the journal the historical information concerning the e-mail whose delivery status is notified by the delivery confirmation mail, in step ST31. In step ST32, the CPU 11 confirms whether the Envelope ID or Message ID notified by the delivery confirmation mail includes the important mail flag. If there is no important mail flag, the CPU 11 confirms the print setting in step ST33.

If it is confirmed that the print setting is “always” in step ST33, the CPU 11 performs print processing concerning the delivery confirmation mail in step ST30. If it is confirmed in step ST33 that the print setting is “only upon failure” or “never”, the CPU 11 terminates the delivery confirmation mail processing without performing step ST30.

In such a manner, if there is no important mail flag, the CPU 11 performs print processing, according to necessity, in accordance with the print setting. However, if the CPU 11 confirms that there is an important mail flag in step ST28 or ST32, the CPU 11 performs print processing in ST30 without executing confirmation in step ST29 or ST33, i.e., regardless of the print setting.

According to the embodiment, as described above, if the print setting is “only upon failure”, only the delivery confirmation mail for notifying delivery failure is printed out. Thus, by setting the print setting as “only upon failure”, the user can recognize delivery failure according to the printed matter, which is based on the delivery confirmation mail, being output. This considerably reduces the load on the user. The paper consumption can also be suppressed.

According to the embodiment, designation whether the e-mail is of importance or not is accepted by the important mail key operation at the time of transmitting the e-mail. If it is designated as being important, a delivery confirmation request is necessarily made. In this case, an important mail flag is written in the Envelope ID and Message ID. If there is an important mail flag in the Envelope ID and Message ID indicated in the delivery confirmation mail, printing is performed regardless of the contents of the notification in the delivery confirmation mail. Thus, while obtaining the above advantage by setting the print setting as “only upon failure” usually, in the case of transmitting a particularly important e-mail, the detailed transmission status of which must be known by the user, the designation as being important is performed, thereby obtaining a printer sheet indicating the delivery status, even if delivery was successful.

According to the embodiment, the user can arbitrarily set “always” and “never”, in addition to “only upon failure”, as the print setting. Thus, flexible operations in response to the user needs can be achieved.

According to the embodiment, a transmitted e-mail is stored. In response to the reception of the delivery confirmation mail which notifies that it is effective to perform retransmission of the e-mail, the e-mail stored is automatically retransmitted. Therefore, there is no need for the user to judge whether or not to retransmit the e-mail based on the contents notified by the delivery confirmation mail, or to perform operations for retransmission. The load on the user can therefore be reduced considerably.

The present invention is not limited to the above embodiment. For example, the relationship between the delivery confirmation information and the delivery result or retransmission setting is not limited to that shown in FIG. 3, and may be arbitrary. For example, the judgment whether “deleted” which is a delivery result notified by the delivery confirmation information, is considered “failed” is divisive. Thus, it can also be defined as “succeeded”. In addition, there is a possibility that the kind of notification indicated by the delivery confirmation information varies, due to different users. Thus, the result in the management table and the contents of the retransmission setting may be changed arbitrarily according to the user designation. This enables flexible operations directed toward the needs of individual users.

In order to retransmit the e-mail, the image data, instead of the e-mail, may be stored. At the time of retransmitting the e-mail, the e-mail may be created again.

The retransmission setting or print setting by the user may be separately performed for each of the DSN and MDN. This makes possible a more flexible management directed towards the various user needs.

The important mail designation may be accepted by the menu operation, instead of a special key such as the important mail key.

It is preferable that the e-mail stored for retransmission be canceled if transmission success has been notified. It is also preferable that the number of retransmission times and storage period be managed, and the e-mail stored for retransmission be canceled if these values exceed the predetermined values.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A facsimile apparatus comprising:
a communication section which performs image data communication utilizing a mail transmission system of a computer network;
a printer which prints an arbitrary image;
a determining section which, if a delivery confirmation mail has arrived, determines whether a delivery failure of the image data transmitted from the communication section is notified by the delivery confirmation mail; and
a control section which causes the printer to print an image based on the delivery confirmation mail, only if the determining section has determined that the delivery failure is notified.

2. A facsimile apparatus according to claim 1, comprising:
an acceptance section which accepts user designation as to whether or not the delivery confirmation mail is requested, if the user requests transmission of the image data; and
a request section which causes the communication section to perform transmission of the image data with the request of the delivery confirmation mail, in response to the acceptance section accepting the user designation that the delivery confirmation mail is requested,
wherein the control section causes the printer to print the image based on the delivery confirmation mail regardless of a determination result of the determining section, if the delivery confirmation mail has arrived in response to the transmission of the image data with the request of the delivery confirmation mail performed under control of the request section.

3. A facsimile apparatus according to claim 1, wherein the communication section transmits an e-mail, to which image data is attached as an attachment file, based on an e-mail protocol.

4. A facsimile apparatus comprising:
a communication section which performs image data communication utilizing a mail transmission system of a computer network;
a storage which stores image data which has been transmitted by the communication section;
a determining section which, if a delivery confirmation mail has arrived, determines whether a delivery failure of the image data transmitted from the communication section is notified by the delivery confirmation mail; and
a control section which causes the communication section to retransmit, when the determining section has determined that the delivery failure is notified, that image data of said image data stored in the storage, which is notified by the delivery confirmation mail as having failed to be delivered.

5. A facsimile apparatus according to claim 4, wherein the determining section determines whether the delivery failure is due to a predetermined cause with which the possibility of success in delivery by retransmission is low,
and the control section does not perform retransmission if the determining section determines that the delivery failure is due to the predetermined cause.

6. A facsimile apparatus according to claim 4, wherein the determining section determines whether the delivery failure of the image data is due to lack of reception capability of a receiving terminal, if the reception capability of the receiving terminal is indicated in the delivery confirmation mail,
and the control section causes the communication section to retransmit the image data in a form receivable with the reception capability indicated in the delivery confirmation mail, if the determining section determines that the delivery failure of the image data is due to the lack of the reception capability of the receiving terminal.

7. A facsimile apparatus according to claim 4, wherein the communication section transmits an e-mail, to which image data is attached as an attachment file, based on an e-mail protocol.

8. A method of controlling a facsimile apparatus having a communication section which performs image data communication utilizing a mail transmission system of a computer network, and a printer which prints an arbitrary image, the method comprising:
determining, if a delivery confirmation mail has arrived, whether a delivery failure of the image data transmitted from the communication section is notified by the delivery confirmation mail, and
causing the printer to print an image based on the delivery confirmation mail, only if has been determined that the delivery failure is notified.

9. A method of controlling a facsimile apparatus having a communication section which performs image data communication utilizing a mail transmission system of a computer network, and a storage which stores image data which has been transmitted by the communication section, the method comprising:
determining, if a delivery confirmation mail has arrived, whether a delivery failure of the image data transmitted from the communication section is notified by the delivery confirmation mail, and
causing the communication section to retransmit, when it has been determined that the delivery failure is notified, that image data of said image data stored in the storage, which is notified by the delivery confirmation mail as having failed to be delivered.
